(19) United States
(12) Patent Application Publication
(10) Pub. No.: US 2005/0058968 A1
(43) Pub. Date: Mar. 17, 2005

(54) Speech (lecture) recorder and printer

(76) Inventor: Happiness Chinedu, Los Angeles, CA (US)

Correspondence Address: HAPPINESS CHINEDU, 4035 COCO AVE APT #2, LOS ANGELES, CA, 90008, US

(21) Appl. No.: 10/662,217

(22) Filed: Sep. 15, 2003

(51) Int. Cl. G09B 27/08; G09B 19/00; G09B 5/04

(52) U.S. Cl. 434/118; 434/321

(57) ABSTRACT

This new and unique method and apparatus is used for recording speeches, lectures, conversation, etc. It also consist of a methods for capturing slides, displays, writings, films, diagrams, equations such as mathematics, physics, chemistry, and calculus, through the help of a detachable tele-cam. It is interconnected to a digital master memory power which enables it to retain information so that it's users can acess desired information and print them out later. The front is layered with super high-powered amplifiers and microphones, which makes it easy for it to capture speeches, lectures, conversations etc., from a distance. It is interconnected to digitally compressed international language memory powers, which enables it to capture speeches, lectures, etc., in any international language of the world, that are used in the classrooms, and print them out.

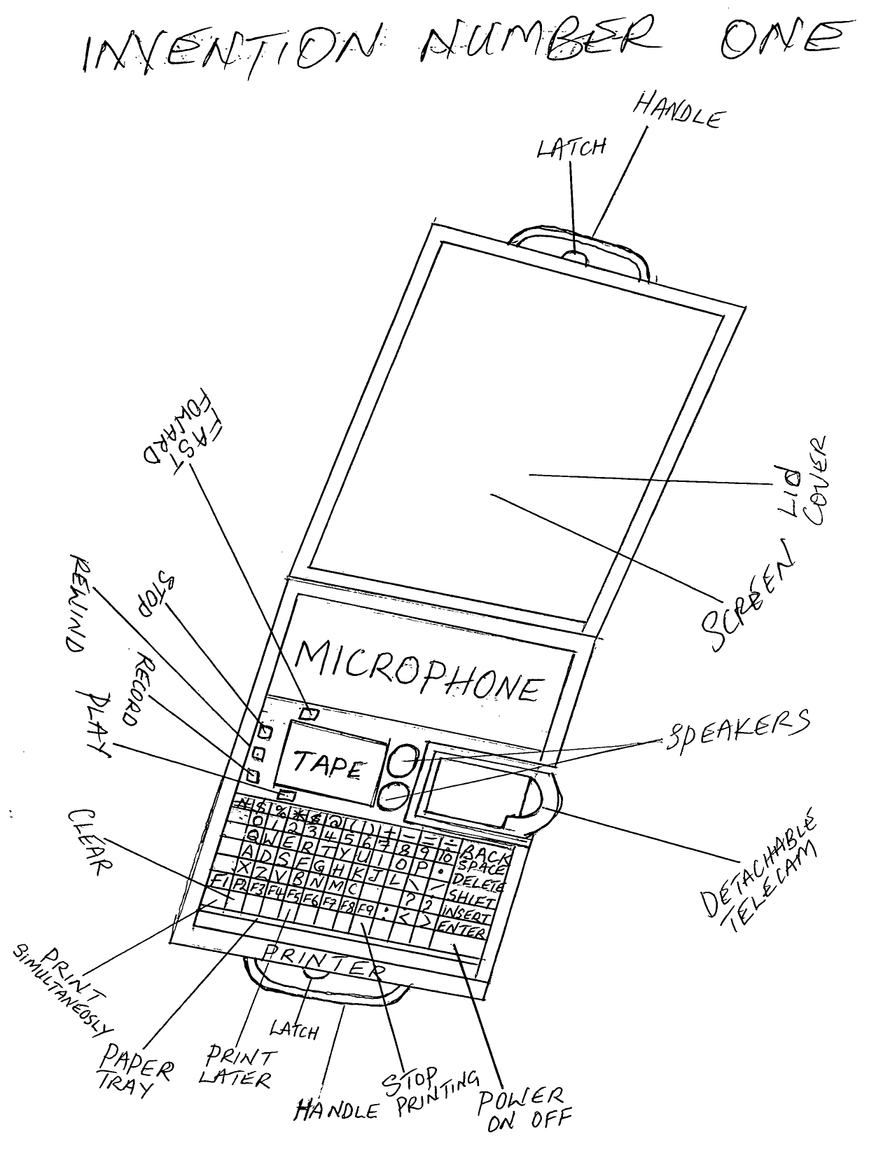

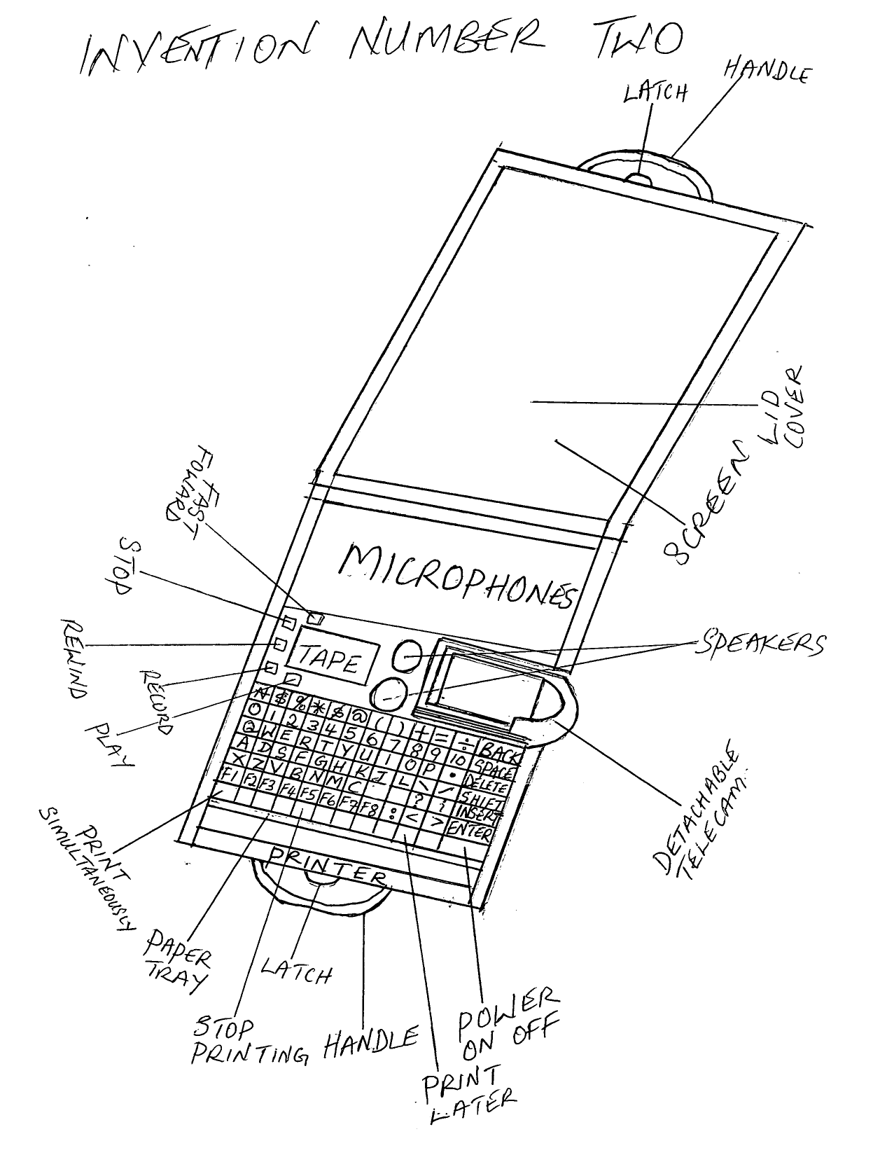

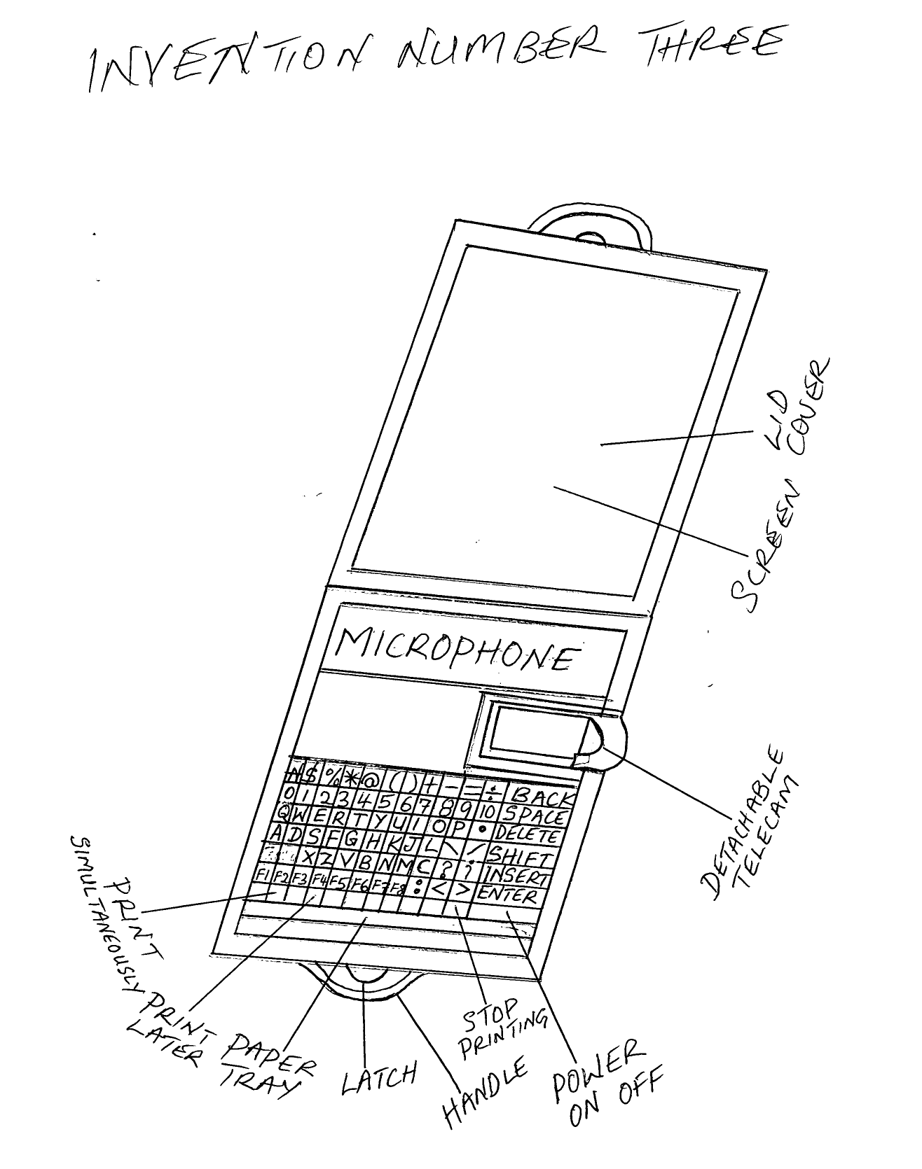

### BRIEF SUMMARY OF THE INVENTION

The present invention contemplates a method and a system, whereby it's users can record or capture speeches, lectures, or voices and print them out on paper.

It also contemplates a method, whereby the user can capture objects, people, movies, slides, displays, diagrams, writings, and equations, such as in mathematics, physics, chemistry, algebra, trigomotry, etc., and print them out on paper.

It is built with a very light material in order to mitigate against weight and heaviness.

It can operate with both electrical cord, and rechargeable batteries. It has a screen for the display of what is being typed or whatever it is capturing. It has an open and closed lid (cover), with a latch.

The top part contains the screen, while the lower part contains all the mechanisms that enables the invention to operate.

Both the speech recorder, printer, typewriter, and the detachable tele-cam have memory power, which enables them to retain whatever information they capture, and then print them out latter.

### A BRIEF DISCRIPTION OF THE DRAWING

The diagram is self explanatory.

It has a large screen which can be opened up all the way, like it would almost touch the table where it is sitting. When closed, the cover (which is the top part) latches tightly to the lower part so that it does not open when it is being carried.

Large powerful microphones, are located in the front top side. The tape recorder is located on the left side with operation buttons, such as play, stop, record, rewind, and fast forward, all located beside it.

The detachable tele-cam is on the right hand side, and the speakers are in the middle.

The typewriter is located in the front side top of the apparatus closest to its users. All it's necessary keys are labeled similar to that of the typewriter.

The printer is at the lower front edge of the apparatus, with it's operation buttons (print-simultaneously, print-later, and stop printing) located close to the typewriter's key.

The paper tray is located in the lower side below the typewriter. The apparatus power button (on and off) is located foremost at the top right hand side close to the typewriter key.

The top where the screen is located and the bottom of where the keys are located, have a latch, and handle components that folds and latches together.

If you notice, I have left certain block spaces in front of the typewriter unlabeled. Every one of those unlabeled spaces are left vacant for builder or the technician, who can best designate specific labels, for them if they are necessary. In other words unlabeled spaces will be filled by the technician.

1. A tape recorder combined with a detachable tele-cam, a printer that can hear and a type writer.

2. A device that enables the printer to hear and to capture lectures, speeches, etc.

3. A device that enables the printer to print out information independent of the tape recorder in other words the printer can hear and capture lectures, speeches, etc and print them out without depending on the tape recorder.

4. A device that enables the printer to retain information that it digitally recorded so that it can be printed out later.

5. A device that enables the printer to print out information simultaneously when the tape recorder is recoding.

6. A device that allow the magnification of letters. Words or information before printing them out (this is optional).

7. A detachable Tele-cam—A device that captures slides, displays, pictures, writings, drawing, diagrams, equations like mathematics, physics, chemistry, etc.

8. A device that enables a detachable Tele-cam to print out captured information.

9. A device that enables a detachable Tele-cam to magnify captured information before printing.

10. A device that enables the users to print out information in color or black and white.

11. A paper tray that can be pushed in and pulled out.

12. Built in microphones and megaphones that serve as voice enhancers.

13. Built in amplifiers to amplify voices.

14. Voice silencer to enable the printer to print without noice.

15. A device that enables printing of recorded items from any source, once the tape of the recorded information is inserted into the tape recorder.

16. A device that enables classroom companion to record, or capture speeches, lectures, etc. in international languages of the world that are used in the classroom and print them out.
